(19) United States
(12) Patent Application Publication
(10) Pub. No.: US 2023/0170586 A1
(43) Pub. Date: Jun. 1, 2023

(54) MICROBATTERY WITH CENTER PIN

(71) Applicant: Tectus Corporation, Saratoga, CA (US)

(72) Inventor: Michael West Wiemer, San Jose, CA (US)

(21) Appl. No.: 17/903,978

(22) Filed: Sep. 6, 2022

Related U.S. Application Data
(60) Provisional application No. 63/283,946, filed on Nov. 29, 2021.

(51) Int. Cl. H01M 50/552; H01R 11/28; H01R 13/04

(52) U.S. Cl. CPC H01M 50/552; H01R 11/281; H01R 13/04

(57) ABSTRACT

A microbattery uses automated machinery to achieve small sizes. The case includes a first terminal that has a hole. A second terminal is located in the hole of the case and is electrically separated from the first terminal. The battery includes two electrodes (anode and cathode). A first electrode is electrically connected to the first terminal. A pin extends through the hole in the first electrode. The pin is electrically connected on one end to the second terminal and on an opposite end to a second electrode.

### CROSS-REFERENCE TO RELATED APPLICATION(S)

This application claims priority under 35 U.S.C. § 119(e) to U.S. Provisional Pat. Application Serial No. 63/283,946, “Contact Lens Battery,” filed Nov. 29, 2021. The subject matter of all of the foregoing is incorporated herein by reference in their entirety.

### BACKGROUND

### 1. Technical Field

This disclosure relates generally to batteries.

### 2. Description of Related Art

Conventional batteries do not meet all the requirements for contact lens batteries in part because they are too big, do not store enough electrical energy, or both. Conventional battery assembly techniques also leave too much dead space inside a battery cell. In some cases only 15% of the volume of a conventional battery is devoted to producing electrical output.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a contact lens containing batteries and electronic modules.

FIG. 2 is a perspective view of a titanium plate that is milled with surface features.

FIGS. 3A-3I are cross-sectional views showing fabrication of contact lens batteries.

FIG. 4 shows an alternative process for insulating a center pin.

FIG. 5A shows a plan and cross-sectional view of a cathode.

FIG. 5B shows a plan and cross-sectional view of an anode.

FIG. 6 shows an alternative process for attaching a lid to a battery case.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Contact lens batteries are designed to reduce wasted space, support a high electrical energy density, and fit inside a contact lens. Advanced battery structures and manufacturing techniques described herein make these goals possible. In fact, the advanced structures may be designed with specific manufacturing techniques in mind.

In one battery architecture, the layers (e.g. anode, cathode, separator, etc.) of a battery are mounted by a pick-and-place machine on a central pin, for example to form a double-cell battery. This results in compact batteries suitable for use in contact lenses.

Modern pick-and-place machines (the Manncorp MC389 is one example among many) can place more than 10,000 surface mount technology (SMT) electronic parts per hour with 30 micron (3 Sigma) placement accuracy. Such machines, or customized industrial robots may be used to assemble contact lens batteries because humans cannot manipulate the small parts of the batteries accurately enough.

Precision robotic assembly techniques allow the manufacture of advanced battery architectures. The resulting batteries are small enough to fit inside a contact lens that is wearable by a human. The battery designs take advantage of the robots’ (and machine tools’) ability to register themselves against alignment marks. This allows precise placement of components and machining around parts hidden under metal layers, for example.

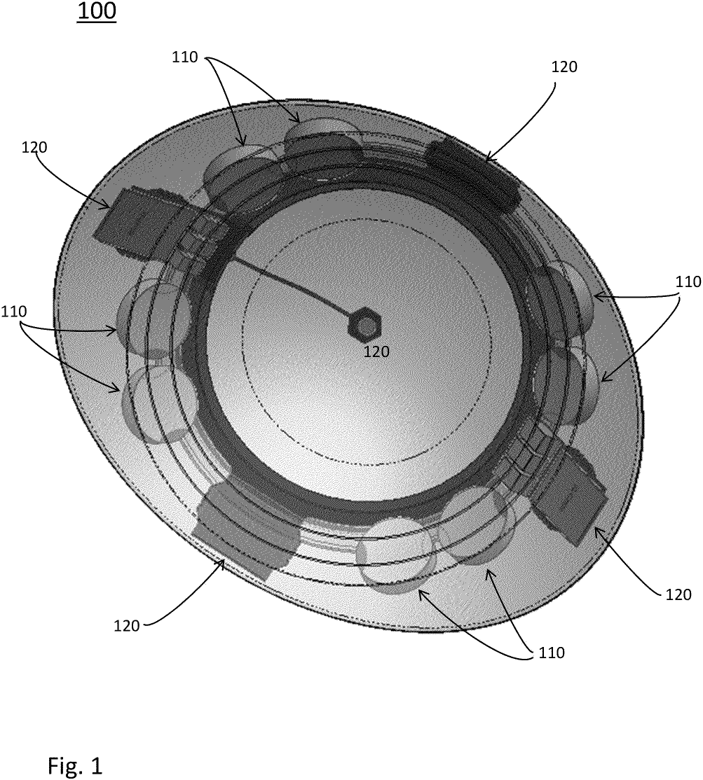

FIG. 1 is a perspective view of a contact lens containing batteries and electronic modules. FIG. 1 shows an electronic contact lens, as seen from the posterior side. The lens contains electronic payloads 120, including in this example, radio communications, data processing, and image projection modules. In this lens, eight cylindrical batteries 110 provide electrical power. However, the batteries need not be cylindrical. In other designs, they may be made in other shapes such as squares, trapezoids, or complicated geometries that fit the space available in the lens.

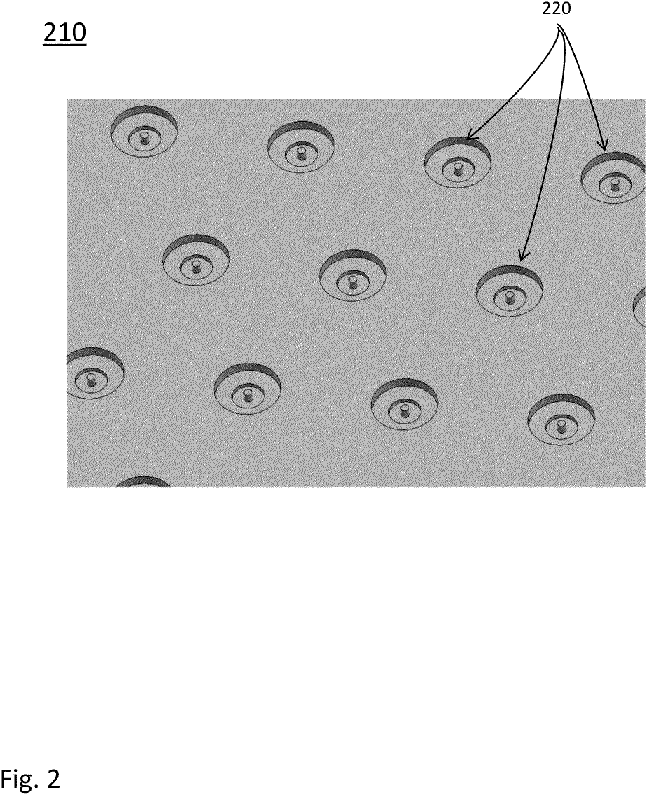

FIG. 2 is a perspective view of a titanium plate 210 that is milled with surface features 220. The features 220 are shown with cylindrical symmetry, but they may also be made in other shapes. Each feature 220 is a precursor to an individual battery. The plate 210 contains many individual precursors 220 and may be referred to as a multi-battery precursor.

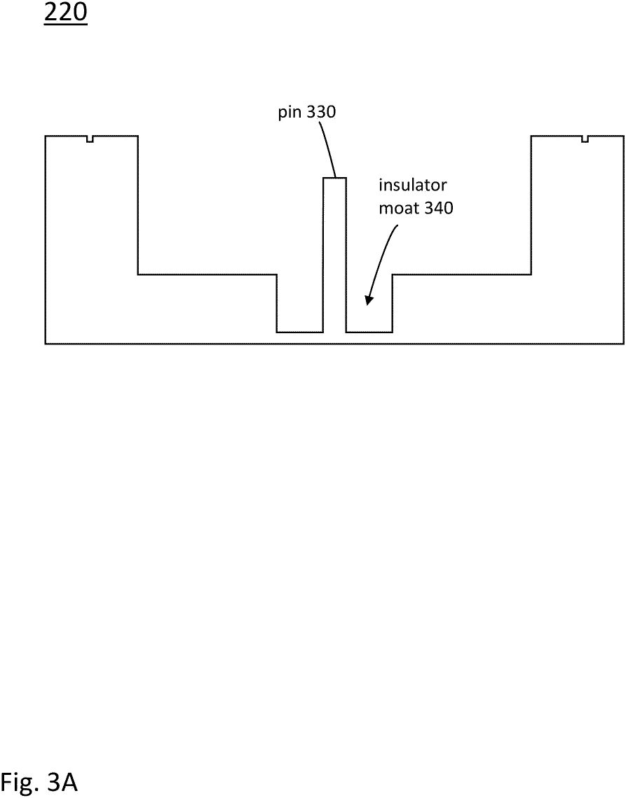

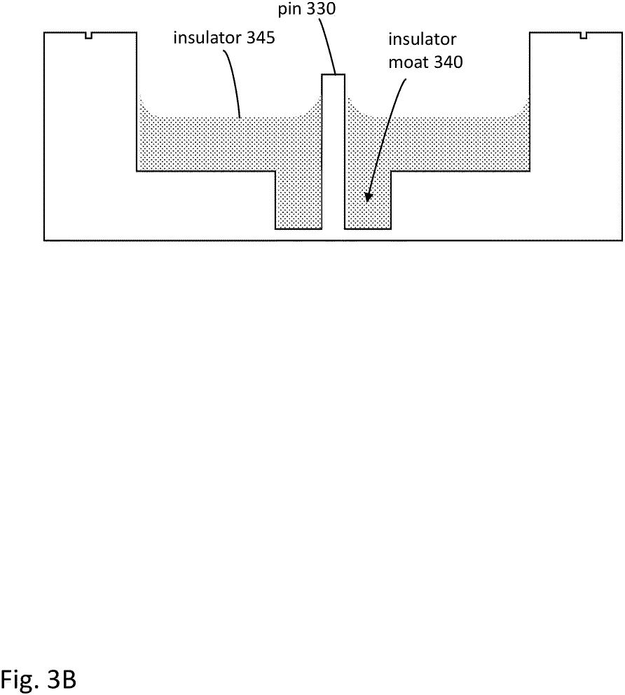

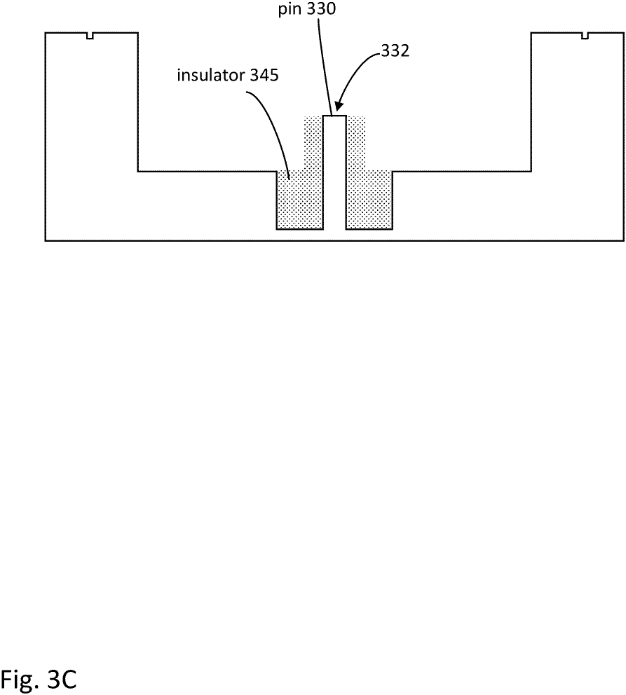

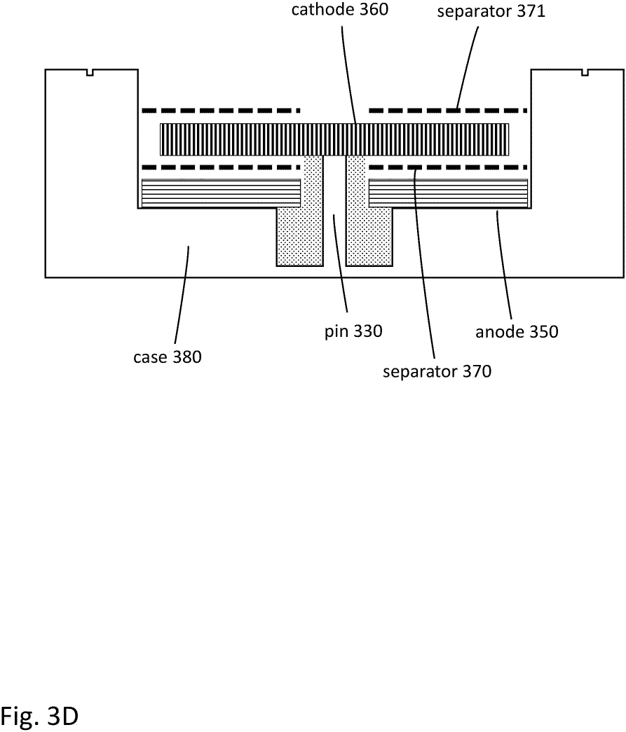

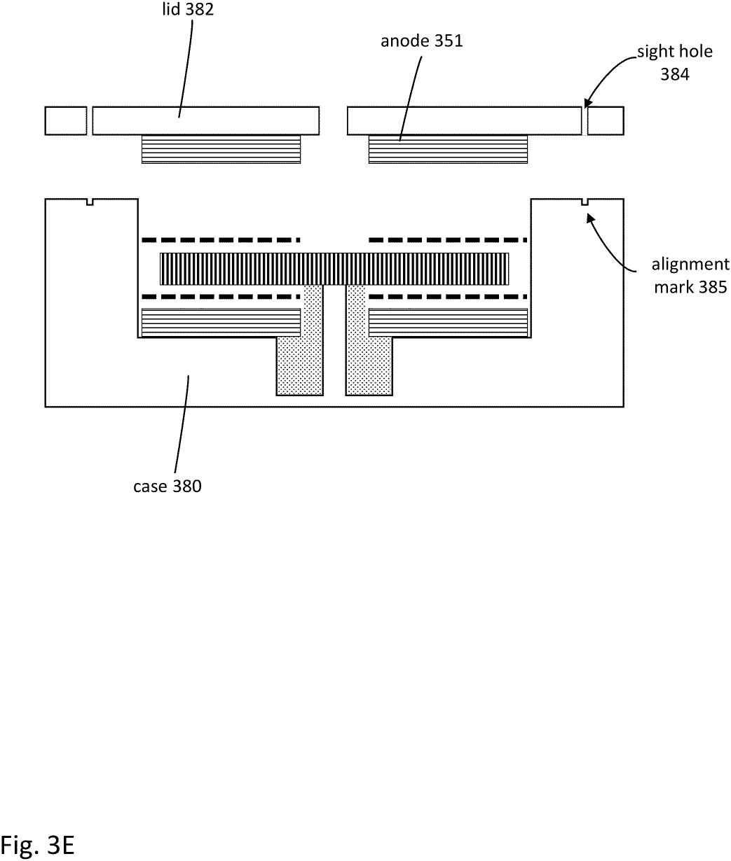

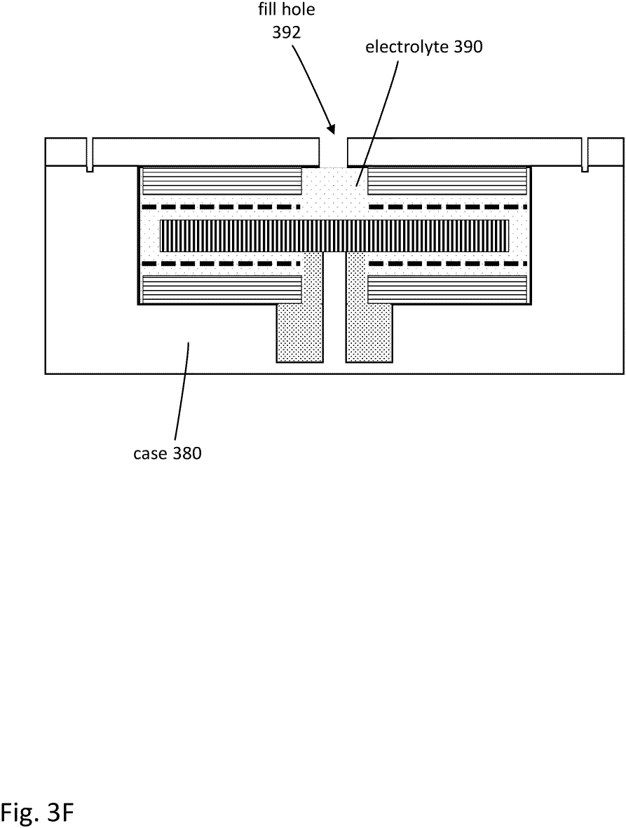

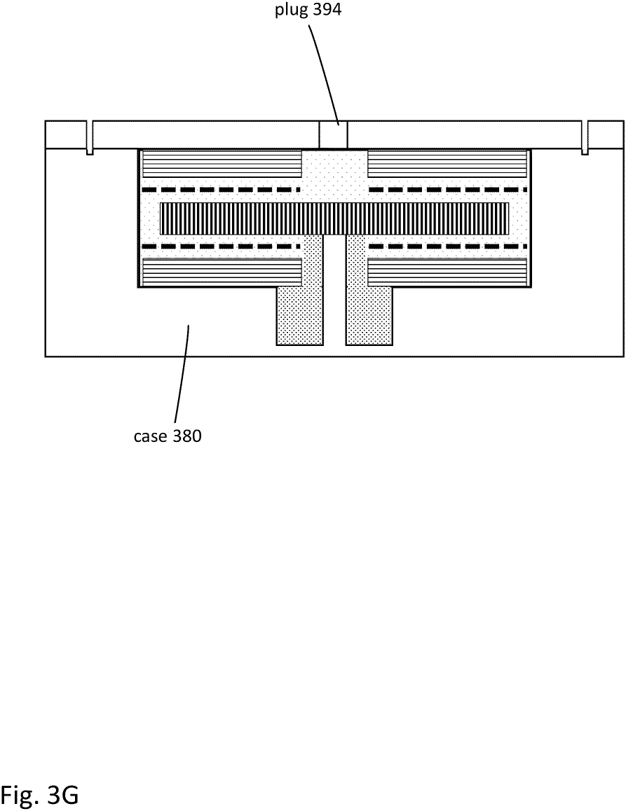

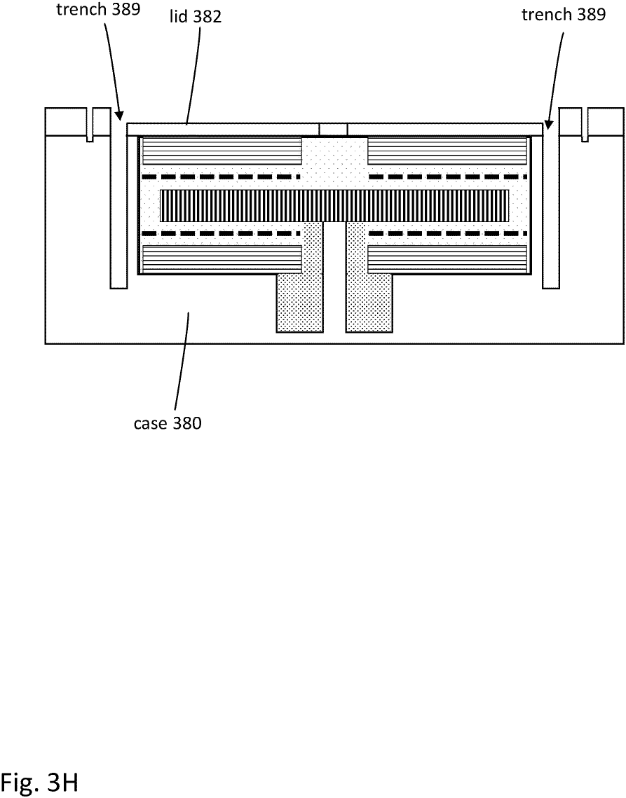

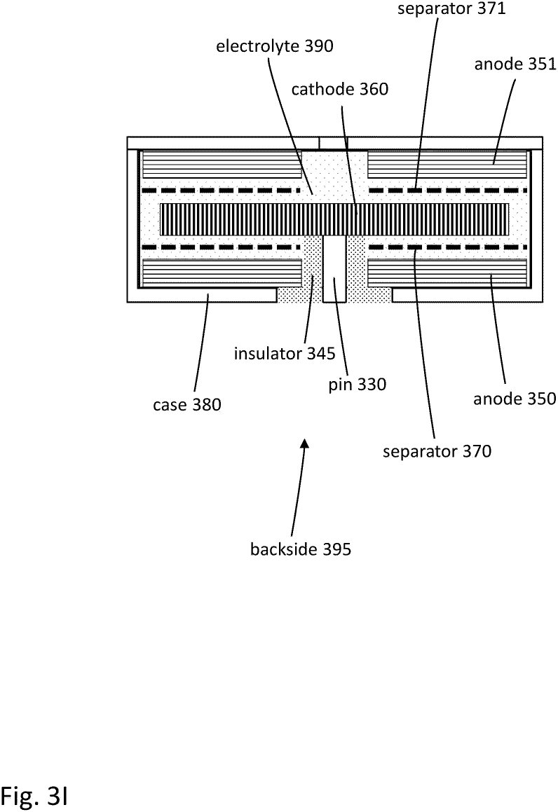

FIGS. 3A-3I are cross-sectional views showing fabrication of contact lens batteries starting with the multi-battery precursor 210 of FIG. 2. FIG. 3A is a cross-sectional view of one of the features 220 milled in the plate. The center pin 330 need not be in the center, although placement near an edge is not preferred. The center pin 330 provides a locator and electrical connection for battery layers assembled in later steps. The insulator moat 340 forms an insulating section of the battery case around the pin 330.

In FIG. 3B, an insulator 345 fills the structure, including the insulator moat 340 around pin 330. Ceramic insulating material may be introduced in bead form and then melted in a furnace, e.g. at 600 - 1000° C. The insulator 345 is machinable, i.e. it can be milled or ground with a mill or grinder, or ablated or processed via laser machining. Alternatively, the insulator 345 may be created by atomic layer deposition (ALD). The insulating material may be Al₂O₃ (aluminum oxide) or other materials that are robust against electrolyte and chemical potentials inside the battery. ALD can create dense material that can fill deep trenches. Other chemical vapor deposition processes may also be used.

In FIG. 3C, the insulating material 345 is ground away to leave an insulated center pin 330 with a conductive surface 332 at its top.

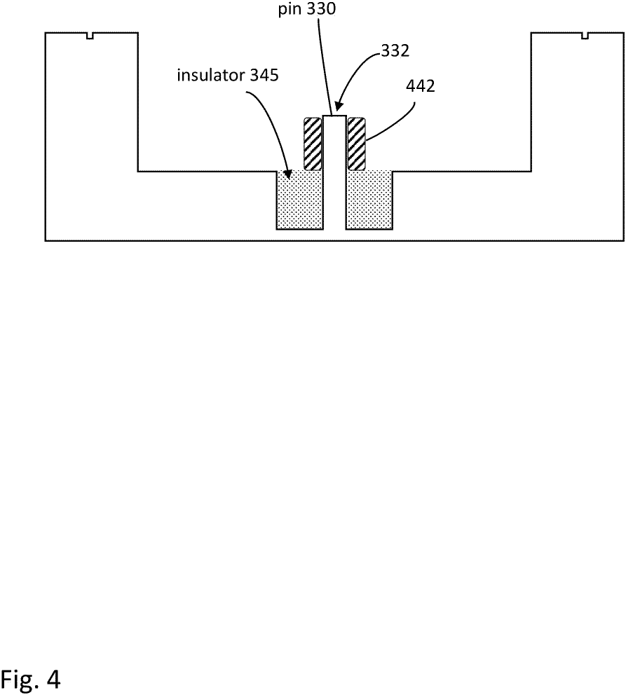

FIG. 4 shows an alternative process. An insulating sleeve 442 fits over the pin 330. The insulating sleeve 442 may be made of plastic. In one example it may have a 100-micron diameter hole, 100-micron wall thickness, and 200 microns length. It may be micro injection molded, or alternatively heat shrunk or sprayed on.

In FIG. 3D, an anode 350, separator 370 and cathode 360 are placed in the case 380, indexed to the pin 330. The anode 350 may be carbon, graphite or lithium. It may be welded ultrasonically to the battery case 380. The separator 370 may be porous polypropylene or polyethylene. The cathode 360 may be lithium cobalt oxide, nickel cobalt manganese or nickel cobalt aluminum as examples. The anode 350 and cathode 360 shown in FIG. 3D will form one battery cell. A second separator 371 is also placed in the case 380 to form a second battery cell.

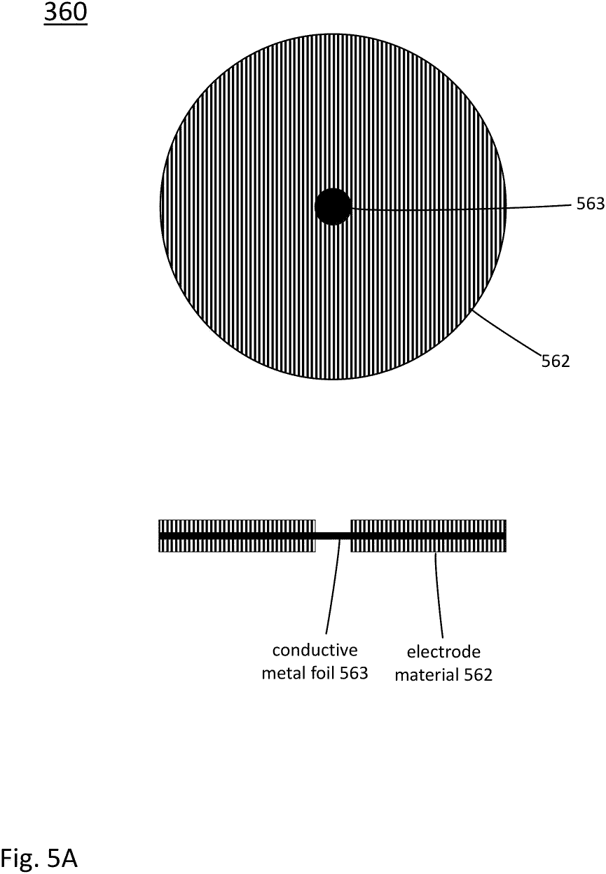

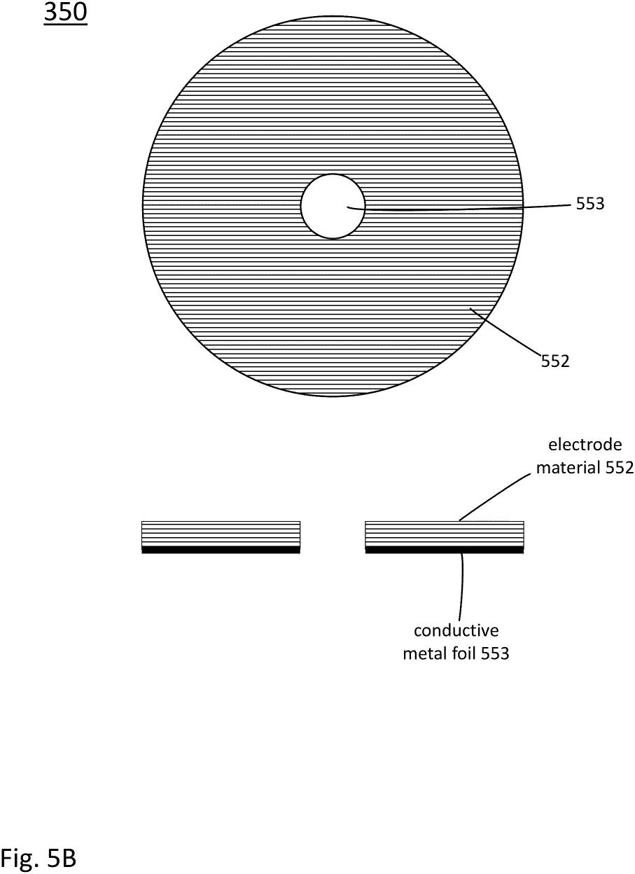

FIG. 5A shows a plan and cross-sectional view of cathode 360 for a cylindrical battery. Other shapes are possible. Electrode material 562 is supported by a conductive metal foil 563. The electrode material 562 has a hole, so that a bare section of the foil 563 makes contact to the center pin 330 in FIG. 3D, for example. The bare section 563 may be made by laser ablating cathode material 562 from a section of the foil.

FIG. 5B shows a plan and cross-sectional view of anode 350 for a cylindrical battery. Other shapes are possible. Electrode material 552 is supported by a conductive metal foil 553 that makes contact to the case 380 in FIG. 3D, for example. Both the electrode material 552 and metal foil 553 have a hole for the center pin 330.

In FIG. 3E, a battery lid 382 is ultrasonically or laser welded to the rest of the case 380. Anode material 351 is welded to the lid 382. The lid 382 has sighting holes 384 through which alignment marks 385 on the case are visible. Each feature in the plate may have its own lid 382, separately aligned to the feature using the alignment marks 385. Alignment may also be achieved kinematically, for example with ball and socket features. Other alignment feature marks and strategies may be used that result in proper lid placement and subsequent processing.

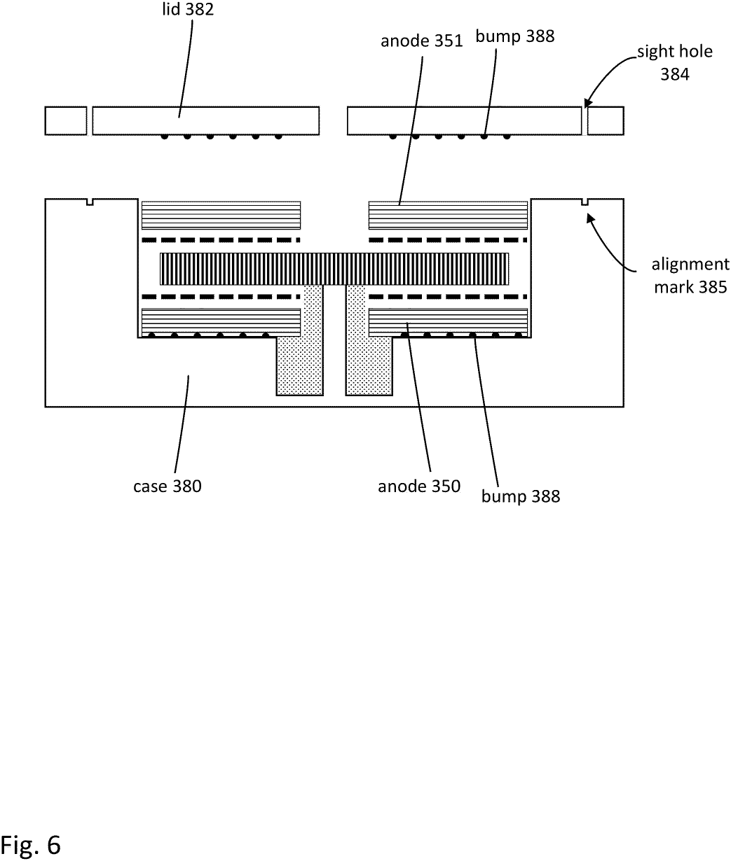

FIG. 6 shows a variation of FIG. 3E. The battery lid 382 is ultrasonically or laser welded to the case 380. Bumps 388 in the lid and case press against anode material 350, 351 without welding. The lid 382 has sighting holes 384 through which alignment marks 385 on the case are visible. Each feature in the plate may have its own lid, separately aligned to the feature using the alignment marks.

In FIG. 3F, an electrolyte 390 is introduced through a fill hole 392. The electrolyte 390 is a mixture of an organic compound(s) such as ethylene carbonate, dimethyl carbonate (DMC), ethyl methyl carbonate (EMC), or diethyl carbonate (DEC), and a salt such as LiPF₆ (lithium hexafluorophosphate). Alternatively, electrolyte 390 may be introduced as the layers of the battery are assembled, thereby eliminating the need to fill at this step. In that case, no fill hole or plug is necessary.

In FIG. 3G, the fill hole is plugged with a welded titanium plug 394, for example.

In FIG. 3H, the lid 382 of the battery is thinned, and trenches 389 are cut to define sidewalls, relying on the alignment marks for placement.

In FIG. 3I, the battery is attached to a carrier, e.g. with wax, and lapped to thin the backside 395 before releasing. The thinning electrically separates the center pin 380 from the rest of the case 382. The thinning also singulates the sheet with multiple features into individual batteries. In FIG. 3I, the main parts of the battery are labeled. The resulting battery may have thin walls and smooth ends, thereby saving valuable space inside a contact lens. The battery in FIG. 3I contains two cells: one formed by anode 351 and cathode 360, and one formed by anode 350 and cathode 360. The two cells are connected in parallel, since anodes 350, 351 are both connected to the case and to each other. In an alternative, the two battery cells may be independent, for example, by electrically separating the top and bottom parts of the case.

In this example, the electrodes 350, 360, 351 and separators 370, 371 are flat, although they may be curved in other designs.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A microbattery comprising:
a case including a first terminal and having a hole;
a second terminal located in the hole of the case and electrically separated from the first terminal;
a first electrode with a hole, the first electrode electrically connected to the first terminal;
a second electrode; and
a pin that extends through the hole in the first electrode, wherein the pin has one end that is electrically connected to the second terminal and an opposite end that is electrically connected to the second electrode.

2. The microbattery of claim 1 wherein the first electrode comprises first electrode material mounted on a conductive carrier that contacts a base of the case.

3. The microbattery of claim 1 wherein the second electrode comprises second electrode material mounted on a conductive carrier that contacts the opposite end of the pin.

4. The microbattery of claim 1 further comprising:
a separator between the first electrode and the second electrode, the separator having a hole with the pin extending through the hole in the separator.

5. The microbattery of claim 1 wherein the case further includes a third terminal, the microbattery further comprising:
a third electrode that is electrically connected to the third terminal; wherein the first electrode and the second electrode form a first battery cell having the first terminal and second terminal as terminals, and the second electrode and the third electrode form a second battery cell having the second terminal and third terminal as terminals.

6. The microbattery of claim 1 further comprising:
a third electrode that is electrically connected to the first terminal of the case; wherein the first electrode and the second electrode form a first battery cell having the first terminal and second terminal as terminals, and the second electrode and the third electrode form a second battery cell having the second terminal and first terminal as terminals.

7. The microbattery of claim 1 wherein the case has a thickness of not more than one mm and a width of not more than 2.5 mm.

8. The microbattery of claim 1 wherein the case is small enough to fit into an electronic contact lens.

9. A microbattery comprising:
a case including a first terminal and having a hole;
a second terminal located in the hole of the case and electrically separated from the first terminal;
a pin that extends from the second terminal to an interior of the case, and electrical insulation to electrically isolate a side of the pin;
a battery stack inside the case, the battery stack comprising, in order extending away from the second terminal:
a flat first electrode comprising first electrode material mounted on a first conductive carrier that contacts the first terminal; wherein the first electrode has a hole and the pin extends through the hole but is electrically separated from the first electrode by the electrical insulation;
a flat first separator, wherein the first separator has a hole and the pin extends through the hole;
a flat second electrode comprising second electrode material mounted on both sides of a flexible second conductive carrier, wherein the second conductive carrier is electrically connected to a top of the pin;
a flat second separator; and
a flat third electrode comprising third electrode material mounted on a third conductive carrier that contacts a cap of the case;
wherein the first and third electrodes are both either anode or cathode, and the second electrode is the other of anode or cathode; and
an electrolyte occupying an interior of the case.

10. The microbattery of claim 9 wherein:
the electrodes comprise at least one of carbon, lithium, lithium cobalt oxide, nickel cobalt manganese or nickel cobalt aluminum;
the electrolyte comprises a mixture of an organic compound and a salt; and
the separators comprise at least one of a porous polypropylene or polyethylene separator.

11. The microbattery of claim 9 wherein the battery stack occupies more than fifteen percent (15%) of an interior volume of the case.

12. A method for fabricating batteries, the method comprising automated machinery performing the following steps:
inserting individual battery stacks into individual cavities in a multi-battery precursor;
wherein the multi-battery precursor contains a plurality of individual precursors for individual batteries, the individual precursors include the individual cavities, and each battery stack comprises a first electrode and a second electrode; and
singulating the multi-battery precursor into the individual precursors containing the individual battery stacks.

13. The method of claim 12 wherein the multi-battery precursor is metal and the individual cavities are milled into the metal to form the individual precursors.

14. The method of claim 12 wherein:
each individual precursor comprises a portion of a case that forms the cavity, and a pin that extends into the cavity, wherein the case and the pin are electrically connected in the multi-battery precursor;
the first electrode contacts the case and the second electrode contacts the pin when the battery stack is inserted into the cavity; and
the method further comprising: thinning the multi-battery precursor, wherein the thinning electrically separates the case and the pin of individual precursors.

15. The method of claim 14 wherein singulating the multi-battery precursor into the individual precursors comprises cutting trenches around each individual precursor, so that thinning the multi-battery precursor singulates the multi-battery precursor into the individual precursors.

16. The method of claim 12 wherein the multi-battery precursor is metal, the method further comprising:
milling the metal to form the individual precursors, each individual precursor comprising a portion of a case that forms the cavity, and a pin that extends into the cavity; and
depositing insulation material in a moat region between the pin and the case.

17. The method of claim 16 wherein depositing insulation material in the moat region comprises: depositing the insulation material using atomic layer deposition.

18. The method of claim 12 wherein the individual precursors include alignment aids, the method further comprising:
attaching lids to the singulated individual precursors using the alignment aids.

19. The method of claim 18 further comprising:
adding electrolyte into the cavities of the individual precursors through a hole in the lid.

20. The method of claim 12 wherein:
each individual precursor comprises a bottom part of a case that forms the cavity, and a pin that extends into the cavity, wherein the case and pin are electrically connected in the multi-battery precursor; and
for each individual precursor, the method further comprises, prior to singulation:
providing electrical insulation to electrically isolate a side of the pin;
inserting the first electrode into the cavity; wherein the first electrode comprises first electrode material mounted on a first conductive carrier the first conductive carrier makes contact with a base of the case, the first electrode has a hole, and the pin extends through the hole but is electrically separated from the first component by the electrical insulation;
overlaying a first separator onto the first electrode;
inserting the second electrode into the cavity; wherein the second electrode comprises second electrode material mounted on both sides of a flexible second conductive carrier, and the second conductive carrier contacts a top of the pin;
overlaying a second separator onto the second electrode; and
attaching a top part of the case and a third electrode to the individual precursors;
wherein the third electrode comprises third electrode material mounted on a third conductive carrier, the third conductive carrier makes contact with the top part of the case, and the third electrode is overlaid onto the second separator; and
thinning the multi-battery precursor, wherein the thinning electrically separates the case and the pin of individual precursors.
